(19) United States
(12) Patent Application Publication
(10) Pub. No.: US 2021/0344811 A1
(43) Pub. Date: Nov. 4, 2021

(54) IMAGE FORMING APPARATUS, BILLING PROCESSING METHOD AND NON-TRANSITORY COMPUTER-READABLE MEDIUM ENCODED WITH BILLING PROCESSING PROGRAM

(71) Applicant: KONICA MINOLTA, INC., Tokyo (JP)

(72) Inventor: Teppei Nakamura, Toyokawa-shi (JP)

(73) Assignee: KONICA MINOLTA, INC., Tokyo (JP)

(21) Appl. No.: 17/225,274

(22) Filed: Apr. 8, 2021

(30) Foreign Application Priority Data
May 1, 2020 (JP) 2020-081182

(51) Int. Cl. H04N 1/34; H04N 1/00; G06Q 20/20; G06Q 30/04

(52) U.S. Cl. CPC H04N 1/346; G06Q 30/04; G06Q 20/20; H04N 1/00411

(57) ABSTRACT

An image forming apparatus includes a document scanner that scans a document, and a hardware processor, wherein the hardware processor acquires image data output by the document scanner that has scanned a document, executes an image forming process of forming an image of the image data output by the document scanner, and executes a collection process of collecting a fee for the image forming process before the image forming process is executed, and the hardware processor executes the collection process in order of output of the image data by the document scanner in the case where the plurality of documents are scanned successively by the document scanner.

The entire disclosure of Japanese patent Application No. 2020-081182 filed on May 1, 2020, is incorporated herein by reference in its entirety.

### BACKGROUND

### Technological Field

The present invention relates to an image forming apparatus, a billing processing method and a non-transitory computer-readable medium encoded with a billing processing program. In particular, the present invention relates to an image forming apparatus that executes a process on the condition that a fee is paid, a billing processing method executed in the image forming apparatus and a non-transitory computer-readable medium encoded with a billing processing program causing a computer that controls the image forming apparatus to execute the billing processing method.

### Description of the Related Art

A service for billing a process executed by an image forming apparatus represented by an MFP (Multi Function Peripheral) has been known. For example, Japanese Patent Laid-Open No. 2018-43471 describes a document printing system in which a computer generates print data of a document and calculates an amount of fee based on the number of pages included in the document and print settings, and an MFP makes notification of a payment code issued by an online settlement service in regard to an amount of fee calculated by the computer, and executes a printing operation using a printer based on the generated print data in the case where a fee is paid via the online settlement service with use of the notified payment code.

However, in the document printing system described in Japanese Patent Laid-Open No. 2018-43471, in the case of a copy process of scanning a plurality of document and forming images, the number of pages subject to the copy process is discovered after all of the plurality of documents are scanned. Therefore, there is a problem that an amount of fee cannot be calculated and collected unless all of the plurality of documents are scanned. Further, in the case where a copy process is interrupted after the fee for the plurality of documents are paid, there is a problem that the paid fee needs to be refunded.

### SUMMARY

According to one aspect of the present invention, an image forming apparatus includes a document scanner that scans a document, and a hardware processor, wherein the hardware processor acquires image data output by the document scanner that has scanned a document, executes an image forming process of forming an image of the image data output by the document scanner, and executes a collection process of collecting a fee for the image forming process before the image forming process is executed, and the hardware processor executes the collection process in order of output of the image data by the document scanner in the case where the plurality of documents are scanned successively by the document scanner.

According to another aspect of the present invention, a billing processing method is executed in an image forming apparatus, and the image forming apparatus includes a document scanner that scans a document, and an image former that forms an image, and the billing processing method includes a scan controlling step of executing a scan process of acquiring image data output by the document scanner that has scanned the document, an image formation controlling step of executing an image forming process of causing the image former to form an image of the image data, and a fee collecting step of executing a collection process of collecting a fee for the image forming process before the image forming process is executed, wherein the fee collecting step includes executing the collection process in order of output of the image data by the document scanner in the case where the plurality of documents are scanned successively by the document scanner.

According to yet another aspect of the present invention, a non-transitory computer-readable medium is encoded with a billing processing program that is executed in a computer that controls an image forming apparatus including a document scanner that scans a document, and the billing processing program causes the computer to execute a scan controlling step of executing a scan process of acquiring image data output by the document scanner that has scanned the document, an image formation controlling step of executing an image forming process of causing the image former to form an image of the image data, and a fee collecting step of executing a collection process of collecting a fee for the image forming process before the image forming process is executed, wherein the fee collecting step includes executing the collection process in order of output of the image data by the document scanner in the case where the plurality of documents are scanned successively by the document scanner.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing an overview of an electronic settlement system in one embodiment of the present invention;

FIG. 2 is a diagram showing one example of a flow of information in the electronic settlement system;

FIG. 3 is a perspective view showing one example of appearance of an MFP;

FIG. 4 is a block diagram showing the outline of a hardware configuration of the MFP;

FIG. 5 is a block diagram showing one example of functions of a CPU included in the MFP;

FIG. 6 is a diagram for explaining scanning of a two-dimensional code by the MFP;

FIG. 7 is a first diagram showing one example of a time chart;

FIG. 8 is a second diagram showing one example of the time chart;

FIG. 9 is a third diagram showing one example of the time chart;

FIG. 10 is a fourth diagram showing one example of the time chart;

FIG. 11 is a fifth diagram showing one example of the time chart;

FIG. 12 is a flowchart showing one example of a flow of a billing process;

FIG. 13 is a flowchart showing one example of a flow of an image forming process; and

FIG. 14 is a flowchart showing one example of a flow of a settlement time determining process.

### DETAILED DESCRIPTION OF EMBODIMENTS

Hereinafter, one or more embodiments of the present invention will be described with reference to the drawings. However, the scope of the invention is not limited to the disclosed embodiments.

An image forming apparatus in embodiments in the present invention will be described below with reference to drawings. In the following description, the same parts are denoted with the same reference characters. Their names and functions are also the same. Thus, a detailed description thereof will not be repeated. Further, in the following description, an MFP is explained as one example of the image forming apparatus. Further, in the MFP described below, a paper (a sheet of paper) such as a plain paper, a wood free paper, a recycled paper or a photo paper, or an OHP (Overhead Projector) sheet is used as a recording medium on which an image is to be formed.

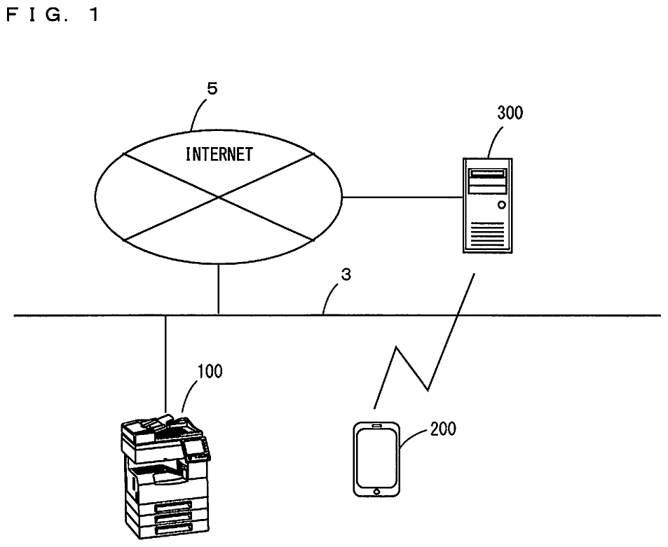

FIG. 1 is a diagram showing the overview of an electronic settlement system in one embodiment of the present embodiment. With reference to FIG. 1, the electronic settlement system 1 includes an MFP (Multi Function Peripheral) 100, a portable information device 200 and a billing server 300. The MFP 100 is one example of the image forming apparatus. The portable information device 200 is a portable computer such as a smartphone or a PDA (Personal Digital Assistant) that is carried and used by a user. In the present embodiment, the portable information device 200 is a smartphone. The billing server 300 is a general computer and one example of a computer that executes electronic settlement transaction.

The MFP 100 is connected to a LAN (Local Area Network) 3, and the LAN 3 is connected to the Internet 5. Therefore, the MFP 100 can communicate with the billing server 300 connected to the Internet 5.

The MFP 100 in the present embodiment executes a process on the condition that a fee for the process to be executed is paid. For example, the MFP 100 bills a fee in the case where executing a copy process of printing image data obtained by scanning of a document, and executes the process on the condition that the fee defined with respect to the copy process is collected.

In the present embodiment, a fee for an image forming process executed by the MFP 100 is collected by electronic settlement. For example, an account assigned to the MFP 100 and an account assigned to the portable information device 200 are respectively registered in the billing server 300. The MFP 100 instructs the billing server 300 to make a payment from the account assigned to the portable information device 200, whereby the billing server 300 executes a settlement process of transferring the requested price from the account assigned to the portable information device 200 to the account assigned to the MFP 100. The MFP 100 acquires the payment information that includes the information specifying the account assigned to the portable information device 200 from the portable information device 200. In the present embodiment, the portable information device 200 displays an image of a two-dimensional code representing payment information, and the MFP 100 acquires the payment information from the portable information device 200 by scanning the image of the two-dimensional code using a camera. While the portable information device 200 displays the two-dimensional code here by way of example, a linear dimensional code may be displayed.

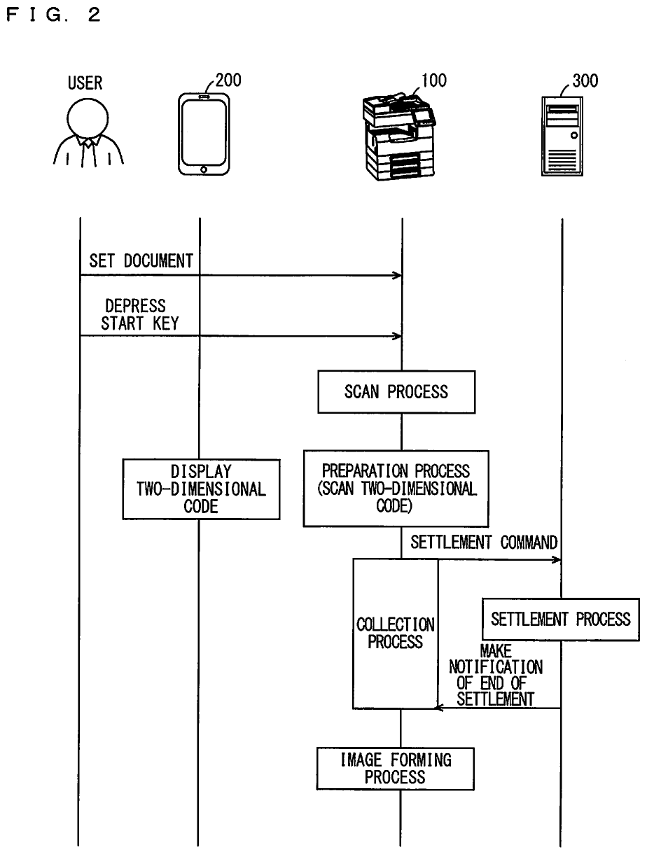

FIG. 2 is a diagram showing one example of a flow of information in the electronic settlement system. With reference to FIG. 2, when the user sets a document subject to a copy process on the MFP 100 and depresses a start key, the MFP 100 executes a scan process and a preparation process.

The scan process is a process of scanning the document and storing image data by the MFP 100. While the preparation process starts after the scan process by way of example in the diagram, the scan process and the preparation process are executed in parallel. In the case where executing the preparation process, the MFP 100 calculates a billing amount and displays a screen requesting a payment of billing amount in a display unit 161. In response, the user causes the portable information device 200 to display an image of a two-dimensional code representing payment information. An application program that is defined to receive an electronic settlement service provided by the billing server 300 is installed in the portable information device 200 in advance, and the image of the two-dimensional code representing the payment information is displayed in a display. The MFP 100 acquires the payment information by scanning the two-dimensional code displayed in the display of the portable information device 200 with the built-in camera. The payment information includes information about a predetermined account assigned to the portable information device 200.

Next, the MFP 100 executes a collection process. An application program that is defined to receive the electronic settlement service provided by the billing server 300 is installed in the MFP 100 in advance, and executes the collection process by executing the application program. Specifically, the MFP 100 generates a settlement command based on the payment information, and transmits the settlement command to the billing server 300. The settlement command is generated based on the payment information represented by the two-dimensional code scanned by the camera, and is an instruction for transferring an amount of fee to the account that is assigned to the MFP 100 and defined by the payment information from the account that is assigned to the portable information device 200 and defined by the payment information. The billing server 300 that receives the settlement command executes a settlement process. Thus, the amount of fee is transferred from the account assigned to the portable information device 200 to the account assigned to the MFP 100 by the billing server 300. The billing server 300 returns a settlement completion notification to the MFP 100 in response to completion of the settlement process. In this manner, the MFP 100 executes the collection process after execution of the preparation process.

The MFP 100 executes the scan process in parallel with the preparation process and the collection process. In response to receiving the settlement completion notification from the billing server 300, the MFP 100 executes an image forming process. An image forming process is a process of forming an image of image data that is obtained by scanning of a document in a scan process on a paper. The MFP 100 executes the image forming process after execution of the scan process.

In this manner, the MFP 100 executes the preparation process, the collection process, the scan process and the image forming process with respect to one document. In this case, because the collection process is executed after the preparation process is executed with respect to one document, the preparation process and the collection process are not executed in parallel with respect to the one document. Further, because the image forming process is executed after the scan process is executed with respect to the one document, the scan process and the image forming process are not executed in parallel with respect to one document. Further, because the image forming process is executed after the collection process is executed with respect to the one document, the collection process and the image forming process are not executed in parallel with respect to the one document.

Not the MFP 100 but the portable information device 200 may execute the collection process. For example, the MFP 100 may notify the portable information device 200 of the amount of fee, and the portable information device 200 may request the billing server 300 to transfer the amount of fee from the account assigned to the portable information device 200 to the account assigned to the MFP 100. Further, the electronic settlement system is not limited to these. Further, while the MFP 100 collects a fee for a process by electronic settlement by way of example, the present invention is not limited to this. A coin collector may be connected to the MFP 100.

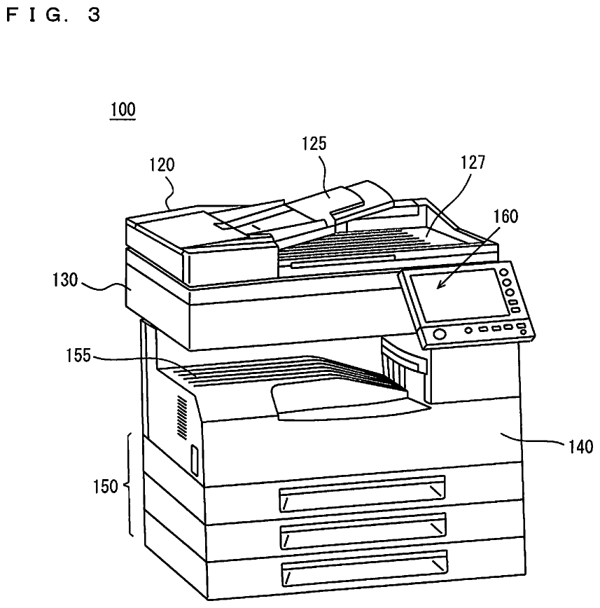

FIG. 3 is a perspective view showing one example of the appearance of the MFP. With reference to FIG. 3, the MFP 100 includes a document scanning unit 130 for scanning a document, an automatic document feeder 120 for conveying a document to the document scanning unit 130, an image forming unit 140 for forming an image on a paper or other medium based on image data, a paper feed unit 150 for supplying papers to the image forming unit 140 and an operation panel 160 serving as a user interface.

The automatic document feeder 120 automatically conveys a plurality of documents set on a document tray 125 to a predetermined document scanning position of the document scanning unit 130 one by one, and discharges a document having an image formed thereon and scanned by the document scanning unit 130 onto a document discharge tray 127.

The document scanning unit 130 includes a light source that emits light and an optoelectronic transducer that receives light, and scans an image formed on a document placed on a scan surface. In the case where a document is placed on a scan region, the light emitted from the light source is reflected by the document, and the reflected light forms an image on the optoelectronic transducer. When receiving the light reflected from the document, the optoelectronic transducer produces image data by converting the received light into an electrical signal.

The paper feed unit 150 conveys papers stored in a paper feed tray to the image forming unit 140. The image forming unit 140 forms an image by a well-known electrophotographic technique, forms an image on a paper conveyed by the paper feed unit 150 based on the image data, and discharges the paper having an image formed thereon to a paper discharge tray 155.

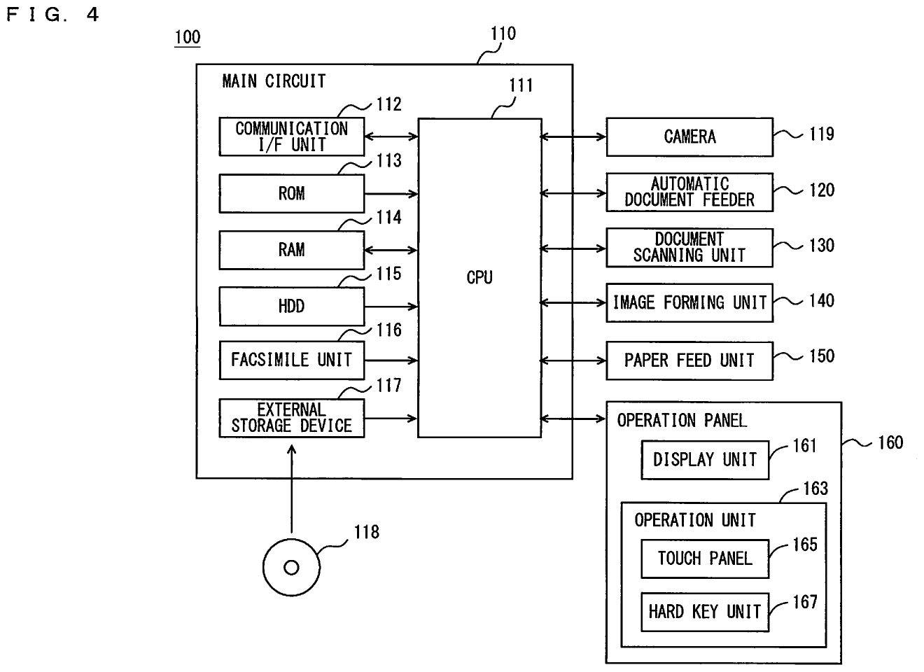

FIG. 4 is a block diagram showing the outline of the hardware configuration of the MFP. With reference to FIG. 4, the MFP 100 includes a main circuit 110. The main circuit 110 includes a CPU (Central Processing Unit) 111 for controlling the entire MFP 100, a communication interface (I/F) unit 112, a ROM (Read Only Memory) 113, a RAM (Random Access Memory) 114, a hard disc drive (HDD) 115 that is used as a mass storage device, a facsimile unit 116 and an external storage device 117. The CPU 111 is connected to the camera 119, the automatic document feeder 120, the document scanning unit 130, the image forming unit 140, the paper feed unit 150 and the operation panel 160, and controls the entire MFP 100.

The ROM 113 stores a program executed by the CPU 111 or data necessary for execution of the program. The RAM 114 is used as a work area for execution of a program by the CPU 111. Further, the RAM 114 temporarily stores image data successively transmitted from the document scanning unit 130.

The operation panel 160 is provided on an upper surface of the MFP 100. The operation panel 160 includes the display unit 161 and an operation unit 163. The display unit 161 is a Liquid Crystal Display (LCD), for example, and displays an instruction menu for the user, information about acquired image data, etc. If being a device that displays images, an organic EL (Electroluminescence) display, for example, can be used instead of an LCD.

The operation unit 163 includes a touch panel 165 and a hard key unit 167. The touch panel 165 is a capacitance type. The touch panel 165 is not limited to the capacitance type, and another type such as a resistive film type, a surface acoustic wave type, an infrared type and an electromagnetic induction type can be used.

The detection surface of the touch panel 165 is provided with its detection surface being superimposed on an upper surface or a lower surface of the display unit 161. Here, the size of the detection surface of the touch panel 165 and the size of the display surface of the display unit 161 are the same. Therefore, the coordinate system of the display surface and the coordinate system of the detection surface are the same. The touch panel 165 detects the position designated by the user on the display surface of the display unit 161 using the detection surface, and outputs a set of coordinates of the detected position to the CPU 111. Because the coordinate system of the display surface and the coordinate system of the detection surface are the same, the set of coordinates output by the touch panel 165 can be replaced with the set of coordinates of the display surface.

The hard key unit 167 includes a plurality of hard keys. The hard keys are contact switches, for example. The touch panel 165 detects a position designated by the user on the display surface of the display unit 161.

The camera 119 is arranged sidewardly of the MFP 100. The camera 119 includes a lens and an optoelectronic transducer and forms an image of light collected by the lens on the optoelectronic transducer. The optoelectronic transducer transduces the received light and outputs the image data to the CPU 111. The optoelectronic transducer is a CMOS (Complementary Metal Oxide Semiconductor) sensor or a CCD (Charge Coupled Device) sensor, for example.

The communication I/F unit 112 is an interface for connecting the MFP 100 to a network. The communication I/F unit 112 communicates with another computer or a data processing apparatus connected to the network with a communication protocol such as TCP (Transmission Control Protocol) or FTP (File Transfer Protocol). The network to which the communication I/F unit 112 is connected is a Local Area Network (LAN), either wired or wireless. Further, the network is not limited to a LAN and may be a Wide Area Network (WAN), a Public Switched Telephone Network (PSTN), the internet or the like. Further, the communication I/F unit 112 includes a wireless communication portion. For example, wireless communication includes wireless communication based on IEEE 802.11 standard, wireless communication based on IEEE 802.15.1 standard and near field wireless communication such as NFC (Near field communication).

The facsimile unit 116 is connected to the Public Switched Telephone Networks (PSTN) and transmits facsimile data to or receives facsimile data from the PSTN. The facsimile unit 116 stores the received facsimile data in the HDD 115, converts the facsimile data into print data that is printable in the image forming unit 140, and outputs the data to the image forming unit 140. Thus, the image forming unit 140 forms an image represented by the facsimile data received from the facsimile unit 116 on a paper. Further, the facsimile unit 116 converts the data stored in the HDD 115 into facsimile data, and transmits the facsimile data to a facsimile machine connected to the PSTN.

The external storage device 117 is controlled by the CPU 111 and mounted with a CD-ROM (Compact Disk Read Only Memory) 118A or a semiconductor memory such as a USB (Universal Serial Bus) memory. While the CPU 111 executes a program stored in the ROM 113 by way of example in the present embodiment, the CPU 111 may control the external storage device 117, read out a program to be executed by the CPU 111 from the CD-ROM 118 and store the read program in the RAM 114 for execution.

It is noted that a recording medium for storing the program executed by the CPU 111 is not limited to the CD-ROM 118. It may be a flexible disc, a cassette tape, an optical disc (MO (Magnetic Optical Disc)/MD (Mini Disc)/DVD (Digital Versatile Disc)), an IC card, an optical card, and a semiconductor memory such as a mask ROM and an EPROM (Erasable Programmable ROM). Further, the CPU 111 may download a program from a computer connected to the network and store the program in the HDD 115, or the computer connected to the network may write the program in the HDD 115. Then, the program stored in the HDD 115 may be loaded into the RAM 114 to be executed by the CPU 111. The program referred to here includes not only a program directly executable by the CPU 111 but also a source program, a compressed program, an encrypted program and the like.

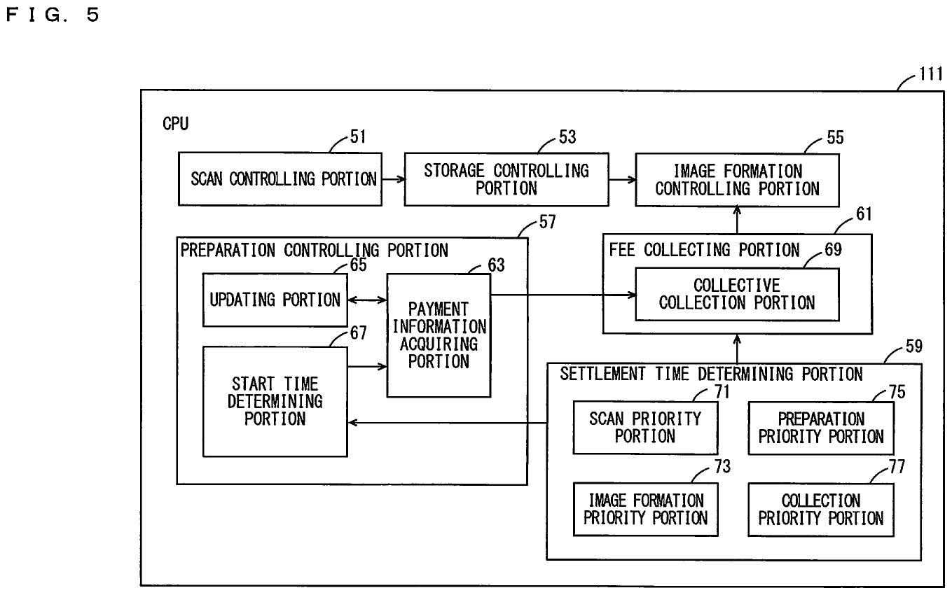

FIG. 5 is a block diagram showing one example of functions of the CPU included in the MFP. The functions shown in FIG. 5 are implemented in the CPU 111 by execution of a billing processing program stored in the ROM 113, the HDD 115 or the CD-ROM 118 by the CPU 111 included in the MFP 100.

With reference to FIG. 5, the CPU 111 includes a scan controlling portion 51, a storage controlling portion 53, an image formation controlling portion 55, a preparation controlling portion 57, a settlement time determining portion 59 and a fee collecting portion 61. The scan controlling portion 51 controls the automatic document feeder 120 and the document scanning unit 130 and executes a scan process. Specifically, the scan controlling portion 51 causes the document scanning unit 130 to scan a plurality of documents set on the document tray 125 one by one. Image data output by the document scanning unit 130 that has scanned the documents is output to the storage controlling portion 53.

The scan controlling portion 51 sets scanning conditions in accordance with an input operation performed by the user with use of the operation unit 163. The scanning conditions are conditions on which a document is scanned by the document scanning unit 130. The scanning conditions include a size of document, a scan mode and resolution, for example. The scan mode includes a color mode in which a document is scanned in color and a monochrome mode in which a document is scanned in monochrome. Image data obtained by scanning in the color mode is constituted by raster data representing brightness of each of red (R), green (G) and blue (B). Image data that is obtained by scanning in the monochrome mode is constituted by raster data representing brightness of black.

The storage controlling portion 53 controls the RAM 114. The storage controlling portion 53 stores image data output by the document scanning unit 130 that has scanned a document in the RAM 114. The storage controlling portion 53 stores image data corresponding to one document in the RAM 114 each time the document scanning unit 130 scans one document. A scan process is not restricted by a preparation process, a collection process or an image forming process. Therefore, the scan controlling portion 51 causes the document scanning unit 130 to scan a plurality of documents set on the document tray 125 in order regardless of progress of each of a preparation process, a collection process and an image forming process. Therefore, a plurality of image data pieces may be stored in the RAM 114.

The image formation controlling portion 55 controls the image forming unit 140 and the paper feed unit 150, and forms an image of image data stored in the RAM 114 on a paper. In response to receiving an execution permission signal from the fee collecting portion 61, described below, the image formation controlling portion 55 forms an image of image data stored in the RAM 114 on a paper. In the case where a plurality of image data pieces are stored in the RAM 114, the image formation controlling portion 55 reads out the image data pieces in the order of storage.

The preparation controlling portion 57 executes a preparation process. The preparation process is a process for execution of a collection process of collecting a fee by the fee collecting portion 61. More specifically, the preparation process is a process of picking up an image of a two-dimensional code displayed in the portable information device 200 and outputting payment information represented by the two-dimensional code to the fee collecting portion 61. Further, the preparation process includes a process of acquiring updated payment information before a validity period of payment information expires. The preparation controlling portion 57 includes a payment information acquiring portion 63, an updating portion 65 and a start time determining portion 67. The payment information acquiring portion 63 controls the camera 119, and causes the camera 119 to pick up an image of a two-dimensional code displayed in the display by the portable information device 200. A two-dimensional code represents payment information and time limit information. Therefore, the payment information acquiring portion 63 analyzes the image of the two-dimensional code and acquires the payment information and the time limit information. The payment information acquiring portion 63 outputs the payment information to the fee collecting portion 61.

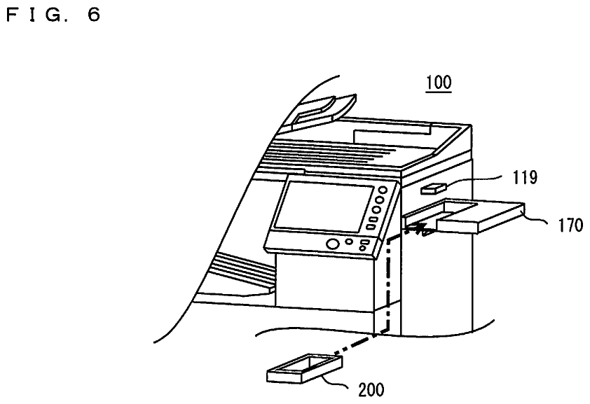

FIG. 6 is a diagram for explaining scanning of a two-dimensional code by the MFP. With reference to FIG. 6, the MFP 100 has a tray 170 on which the portable information device 200 is placed. The tray 170 has a platform on which the camera 119 can be arranged. The user places the portable information device 200 on the tray 170. The position of platform of the tray 170 is defined such that the display of the portable information device 200 fits in an imaging range of the camera 119 with the portable information device 200 placed on the platform.

The user causes the portable information device 200 to start an application program when placing the portable information device 200 on the tray 170. The application program is an application program installed in the portable information device 200 in advance to receive the electronic settlement service provided by the billing server 300. Thus, an image of a two-dimensional code is displayed in the display of the portable information device 200.

Returning to FIG. 5, the payment information acquiring portion 63 controls the camera 119 and causes the camera 119 to pick up the image of the two-dimensional code displayed in the display of the portable information device 200. The payment information acquiring portion 63 analyzes the image of the two-dimensional code output by the camera 119 and acquires payment information and time limit information. The payment information is the information that permits payment from an account assigned to the user who carries the portable information device 200. A validity period of the payment information is defined, and the payment information becomes invalid when the validity period expires. The payment information the validity period of which has expired is not accepted by the billing server 300. The time limit information represents the period during which the payment information is valid. The payment information acquiring portion 63 outputs the payment information to the fee collecting portion 61 and outputs the time limit information to the updating portion 65.

Based on the time limit information received from the payment information acquiring portion 63, the updating portion 65 controls the portable information device 200 and causes the portable information device 200 to display a newly updated two-dimensional code before the payment information becomes invalid. Specifically, the updating portion 65 controls the portable information device 200 by wirelessly communicating with the portable information device 200 via the communication I/F unit 112. Before the validity period defined by the time limit information expires, the updating portion 65 transmits an update command to the portable information device 200 and causes the portable information device 200 to display an image of a two-dimensional code representing new payment information and new time limit information. Further, the updating portion 65 outputs an update instruction to the payment information acquiring portion 63 together with transmission of the update command. In response to receiving the update instruction from the updating portion 65, the payment information acquiring portion 63 controls the camera 119, causes the camera 119 to pick up an image of a two-dimensional image and acquires payment information and time limit information.

The start time determining portion 67 determines a point in time at which a preparation process starts. When the preparation process is executed initially, the start time determining portion 67 determines a measured period of time from the start to the end of the preparation process as a preparation period of time required for the preparation process. The start time determining portion 67 sets a point in time at which a preparation process with respect to a document that comes second in a queue starts to a point in time at which a preparation with respect to a document that comes first in the queue ends. The start time determining portion 67 determines a point in time earlier than a settlement time determined by the settlement time determining portion 59 by the preparation period of time as a point in time at which a preparation process with respect to documents that come third and subsequently in the queue starts. The payment information acquiring portion 63 receives a start point in time from the start time determining portion 67, acquires payment information at the start point in time and outputs the payment information to the fee collecting portion 61. Further, in the case where receiving an update instruction from the updating portion 65 after outputting payment information to the fee collecting portion 61, the payment information acquiring portion 63 outputs payment information that is acquired thereafter to the fee collecting portion 61.

In response to receiving a settlement instruction from the settlement time determining portion 59, the fee collecting portion 61 executes a collection process. Specifically, the fee collecting portion 61 collects a fee for an image forming process executed by the image formation controlling portion 55 based on payment information received from the preparation controlling portion 57. An amount of fee is defined based on conditions of an image forming process executed by the image formation controlling portion 55. A fee is defined by a size of paper subject to image formation, for example. Further, a fee is defined whether an image is printed in color or monochrome. Further, a fee is defined based on a type of an image process executed with respect to image data. The types of image process are a resolution conversion process of converting resolution, an edge enhancement process of enhancing an edge of an image of character and a smoothing process of reducing a change in darkness of an image of a photo.

In order to collect a fee, the fee collecting portion 61 communicates with the billing server 300 and requests the billing server 300 to transfer an amount equivalent to an amount of fee. Specifically, the fee collecting portion 61 transmits a settlement command to the billing server 300. Although not limited, a settlement command is a command to provide an instruction for transferring an amount equivalent to an amount of fee from a payer's account to a payee's account. A payer's account is an account assigned to the portable information device 200 represented by payment information, and a payee's account is an account assigned to the MFP 100. When receiving a settlement command, the billing server 300 executes a settlement process. When the settlement process ends, the billing server 300 transmits a settlement completion notification to the MFP 100. A settlement process is a process of transferring an amount equivalent to an amount of fee from a payer's account to a payee's account. In response to receiving the settlement completion notification from the billing server 300, the fee collecting portion 61 outputs an execution permission signal to the image formation controlling portion 55. Thus, an image forming process of forming an image of image data corresponding to a document on a paper is executed by the image formation controlling portion 55.

In the case where a plurality of documents are scanned successively by the document scanning unit 130, the settlement time determining portion 59 determines a settlement time at which the fee collecting portion 61 starts a collection process with respect to documents that come second and subsequently in a queue. First, the settlement time determining portion 59 measures a preparation period of time and a collection period of time in regard to a document that comes first in the queue. The preparation period of time is a period of time during which a preparation process is executed by the preparation controlling portion 57. A scan period of time is a period of time during which the scan controlling portion 51 executes a scan process, and is specifically a period of time from the time when a document is scanned until the time when image data is stored in the RAM 114. The scan period of time is defined by a size of document and unique to the MFP 100. Specifically, an image formation period of time is a period of time during which the image formation controlling portion 55 forms an image of image data on a paper. The image formation period of time is a value defined by a size of paper and unique to the MFP 100. Therefore, the scan period of time and the image formation period of time may be a predetermined period of time.

The settlement time determining portion 59 determines any point in time as a point in time at which the scan controlling portion 51 executes a collection process with respect to image data obtained by the scan controlling portion 51 that has scanned a document that comes first in a queue. Here, the preparation controlling portion 57 executes a preparation process after the start key is depressed by the user, and a point in time at which the preparation process ends is determined as a settlement time. The fee collecting portion 61 starts a collection process at the settlement time. The settlement time determining portion 59 measures a collection period of time during which the collection process is executed.

Meanwhile, in response to depression of the start key by the user, the scan controlling portion 51 starts a scan process with respect to the document that comes first in the queue. The settlement time determining portion 59 may measure a period of time during which the scan controlling portion 51 executes the scan process with respect to the document that comes first in the queue as a scan period of time. Further, when the fee collecting portion 61 executes a collection process, an execution permission signal is output to the image formation controlling portion 55. Therefore, the image formation controlling portion 55 executes an image forming process with respect to the document that comes first in the queue. The settlement time determining portion 59 may measure a period of time during which the image formation controlling portion 55 executes the image forming process with respect to the document that comes first in the queue as an image formation period of time.

The settlement time determining portion 59 determines a point in time at which a collection process with respect to documents that come second and subsequently in the queue starts as a settlement time. The settlement time determining portion 59 outputs the settlement time to the start time determining portion 67, and outputs a settlement instruction to the fee collecting portion 61 when a current point in time becomes the settlement time. The settlement time determining portion 59 includes a scan priority portion 71, an image formation priority portion 73, a preparation priority portion 75 and a collection priority portion 77. Hereinafter, a period of time during which a preparation process is executed is referred to as a preparation period, a period of time during which a collection process is executed is referred to as a collection period, a period of time during which a scan process is executed is referred to as a scan period and a period of time during which an image forming process is executed is referred to as an image formation period.

In the case where any of a preparation period and a collection period is equal to or smaller than a scan period and equal to or smaller than an image formation period, and the scan period is equal to or larger than the image formation period, the scan priority portion 71 selects a scan priority mode. In the case where the scan priority mode is selected, the settlement time determining portion 59 determines a settlement time at which a collection process starts such that the collection process with respect to a document subject to a scan process is executed during execution of a scan process with respect to documents that come second and subsequently in a queue. For example, the settlement time determining portion 59 determines a point in time at which the scan process with respect to the documents that come second and subsequently in the queue starts as the settlement time at which the collection process with respect to the document subject to the scan process starts. Preferably, the scan priority portion 71 determines the settlement time at which a collection process with respect to the second document starts such that a collection process with respect to the second document that is scanned subsequently to the first document ends at a point in time at which a scan process with respect to a first document ends or later. For example, the settlement time determining portion 59 determines a point in time that is earlier than a point in time at which the scan process with respect to the first document ends by a collection period as a settlement time at which the collection process with respect to the second document starts. Therefore, a period of time from the time when a fee for the second document is collected until the time when an image forming process is executed is as short as possible. Therefore, likelihood of collection of the fee for the second document when an image forming process with respect to the second document is interrupted can be lowered.

In the case where any of a preparation period and a collection period is equal to or smaller than a scan period and equal to or smaller than an image formation period, and the scan period is smaller than the image formation period, the image formation priority portion 73 selects an image formation priority mode. In the case where the image formation priority mode is selected, the settlement time determining portion 59 determines a settlement time at which a collection process with respect to a second document starts such that a collection process with respect to the second document that is scanned subsequently to a first document ends at a point in time at which an image forming process with respect to the first document ends or later. For example, the settlement time determining portion 59 determines a point in time that is earlier than a point in time at which the image forming process with respect to the first document ends by a collection period as a settlement time at which the collection process with respect to the second document starts. Thus, the collection process with respect to the second document starts after the image forming process with respect to the first document ends. Therefore, a period of time from the time when a fee for the second document is collected until the time when an image forming process is executed is as short as possible. Therefore, likelihood of collection of the fee for the second document when the image forming process with respect to the second document is interrupted can be lowered.

In the case where a preparation period is larger than any of a scan period and an image formation period, and the preparation period is larger than a collection period, the preparation priority portion 75 selects a preparation priority mode. In the case where the preparation priority mode is selected, the settlement time determining portion 59 determines a settlement time such that a collection process with respect to a document subject to a preparation process starts after the preparation process ends. Because a preparation period is larger than any of a scan period and an image formation period and is equal to or larger than a collection period, the preparation process is a bottleneck. In this case, it is most efficient to execute preparation processes successively. Therefore, in the preparation priority mode, a preparation process with respect to a second document that is scanned subsequently to a first document starts after a preparation process with respect to the first document ends. For example, the settlement time determining portion 59 determines a point in time at which a preparation process ends as a settlement time at which a collection process with respect to a document subject to the preparation process starts. As long as a settlement time is earlier than a point in time at which a preparation process for the next document ends by a collection period, the settlement time can be delayed.

In the case where a collection period is larger than any of a scan period and an image formation period, and a preparation period is equal to or smaller than the collection period, the collection priority portion 77 selects a collection priority mode. In the case where the collection priority mode is selected, the settlement time determining portion 59 determines a settlement time such that a collection process with respect to a second document that is scanned subsequently to a first document starts after a collection process with respect to the first document ends. Because a collection period is larger than any of a scan period, an image formation period and a preparation period, the collection process is a bottleneck. In this case, it is most efficient to execute collection processes successively. For example, the settlement time determining portion 59 determines a point in time at which a collection process with respect to a first document ends as a settlement time at which a collection process with respect to a second document starts.

While the fee collecting portion 61 executes a collection process in response to receiving a settlement instruction from the settlement time determining portion 59, in the case where the settlement time determining portion 59 selects a preparation priority mode or a collection priority mode, a plurality of image data pieces which are subject to an image forming process and for which fees are not collected may be stored in the RAM 114 at a point in time at which the settlement instruction is received. The fee collecting portion 61 includes a collective collection portion 69. In the case where a plurality of image data pieces which are subject to an image forming process and for which fees are not collected are stored in the RAM 114 at a point in time at which a settlement instruction is received, the collective collection portion 69 collectively collects fees for an image forming process with respect to the plurality of image data pieces. Therefore, a collection process is executed once with respect to the plurality of documents. Therefore, it is possible to collect fees efficiently and shorten a period of time required for a copy process with respect to the plurality of documents.

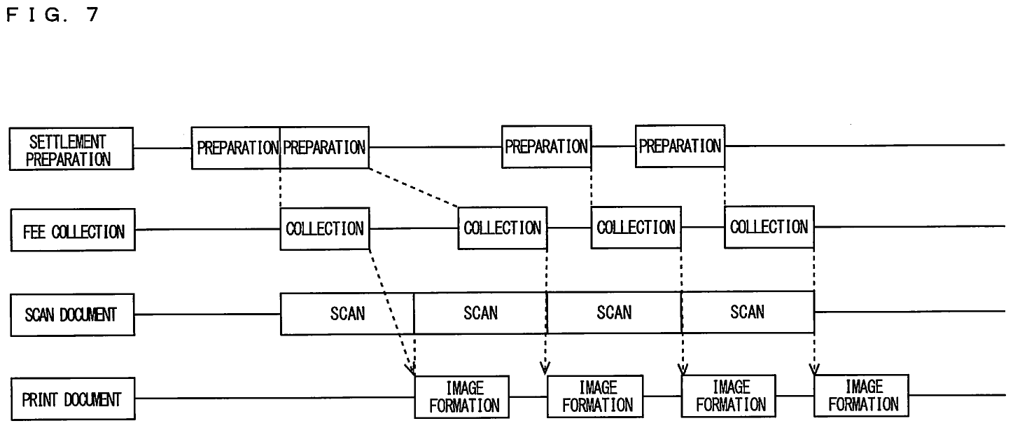

FIG. 7 is a first diagram showing one example of a time chart. FIG. 7 shows the time chart in case of a scan priority mode. With reference to FIG. 7, a fee for a process with respect to image data is collected in a period during which the document scanning unit 130 scans documents that come second and subsequently in a queue. Therefore, because a waiting period of time from the time when the documents that come second and subsequently in the queue are scanned until the time when images of image data of the documents are formed is not generated, a copy process is executed efficiently.

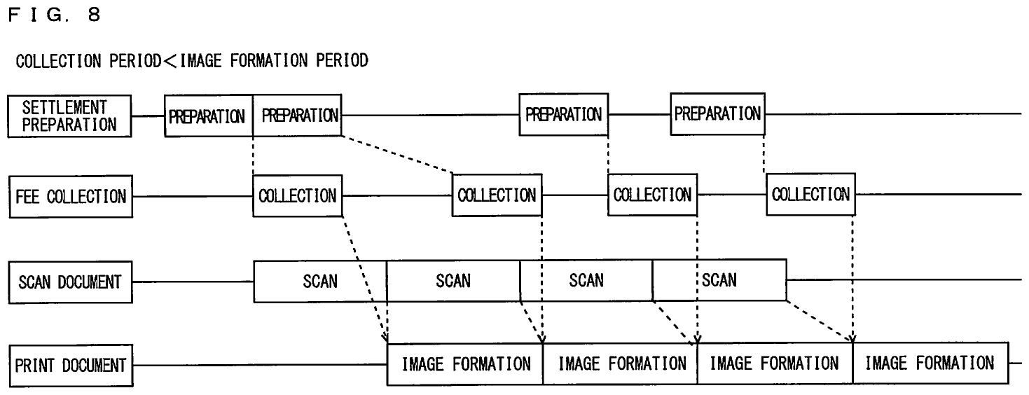

FIG. 8 is a second diagram showing one example of the time chart. FIG. 8 shows the time chart in case of an image formation priority mode. With reference to FIG. 8, before the image forming unit 140 starts an image forming process with respect to the documents that come second and subsequently in the queue, a collection process of collecting fees for the image forming process ends. Therefore, a fee for an image forming process with respect to image data corresponding to a document that comes subsequently in a queue to a document corresponding to image data for which the image forming unit 140 is forming an image can be prevented from being collected before an image forming process with respect to the image data corresponding to a document one document before in a queue ends. For example, a fee for an image forming process with respect to a document that comes third in the queue can be prevented from being collected before an image forming process with respect to a document that comes second in the queue is completed. Thus, in the case where the image forming process with respect to the document that comes third in the queue is interrupted before the image forming process with respect to the document that comes second in the queue is completed, the fee for the image forming process with respect to the document that comes third in the queue can be prevented from being collected. In the case where the fee for the image forming process with respect to the document that comes third in the queue is collected before the image forming process with respect to the document that comes third in the queue is interrupted, the fee for the image forming process with respect to the document that comes third in the queue must be refunded. However, it is not necessary to refund the fee for the image forming process with respect to the document that comes third in the queue.

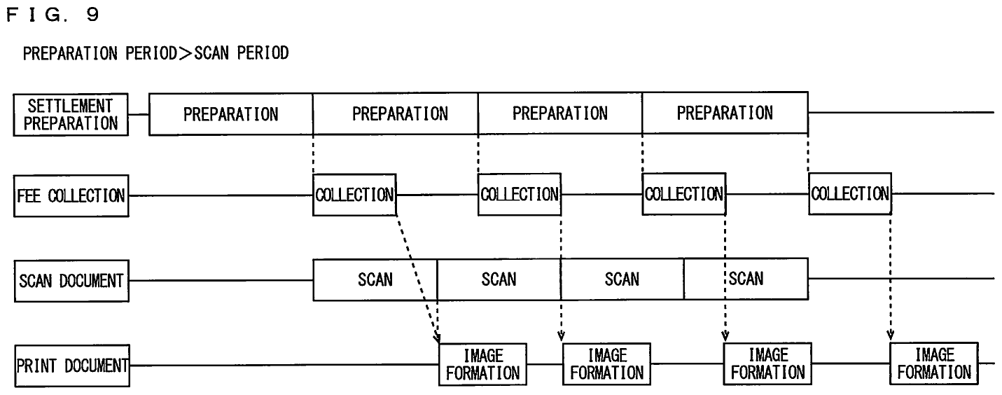

FIG. 9 is a third diagram showing one example of the time chart. FIG. 9 shows the time chart in case of a preparation priority mode. With reference to FIG. 9, a collection process is executed immediately after a preparation process ends. A preparation process can be executed in parallel with a scan process and an image forming process, and requires a long period of time, thereby being a bottleneck. In the case where a preparation process is a bottleneck, it is most efficient to execute preparation processes successively.

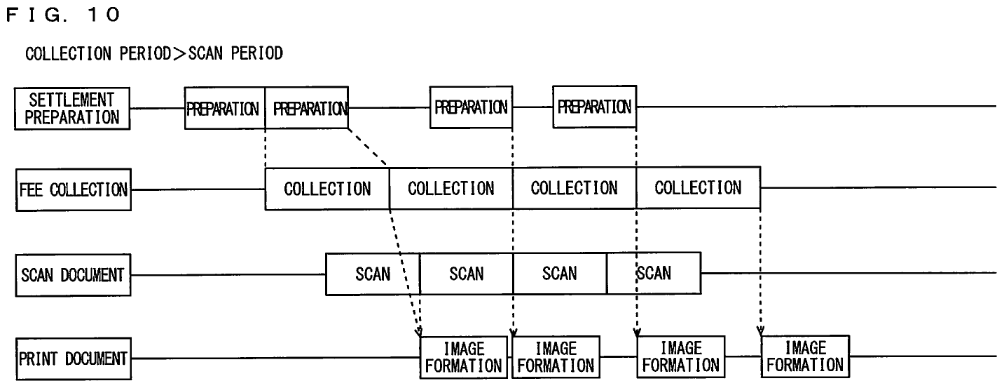

FIG. 10 is a fourth diagram showing one example of the time chart. FIG. 10 shows the time chart in case of a collection priority mode. With reference to FIG. 9, a collection process is executed immediately after a collection process with respect to a document that comes previously in a queue ends. A collection process can be executed in parallel with a scan process and an image forming process, and the collection process is a bottleneck. In the case where a collection process is a bottleneck, it is most efficient to execute collection processes successively.

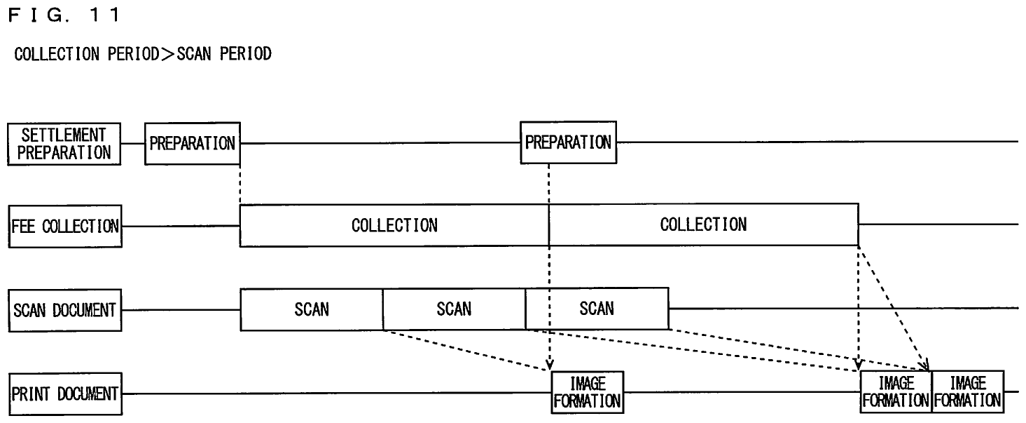

FIG. 11 is a fifth diagram showing one example of the time chart. FIG. 11 shows the time chart in the case where a collection period is equal to or larger than twice of a scan period. With reference to FIG. 11, at a point in time at which a collection process with respect to a document that comes first in a queue ends, a scan process with respect to a document that comes second in the queue ends, and a scan process with respect to a document that comes third in a queue is in progress. In this case, a collection process is executed collectively for both of the documents that come second and third in the queue.

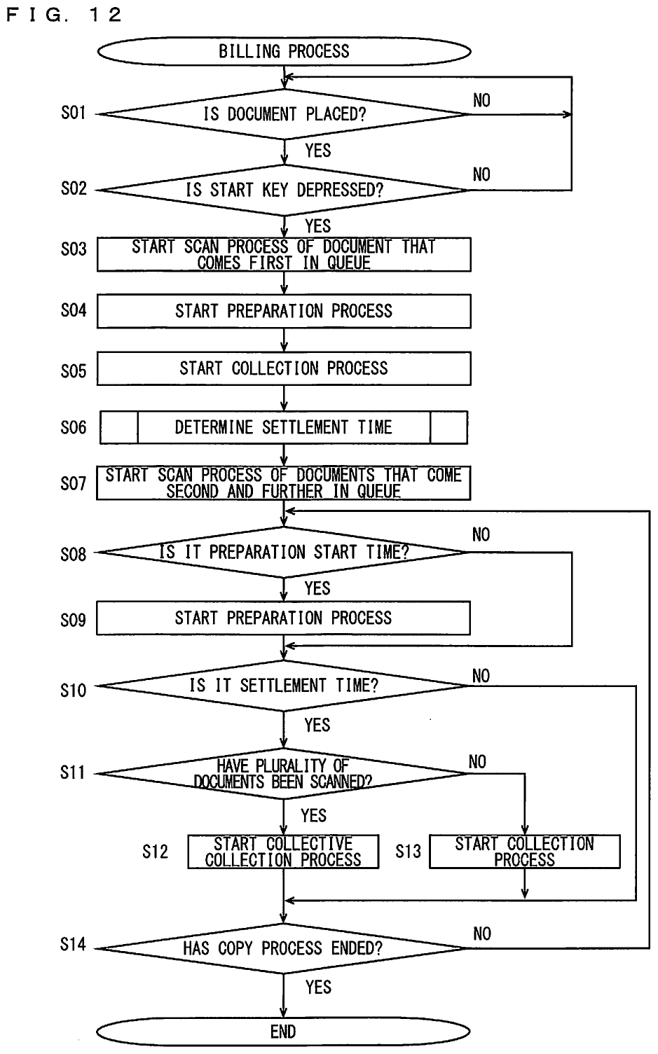

FIG. 12 is a flowchart showing one example of a flow of a billing process. The billing process is a process executed by the CPU 111 when the CPU 111 included in the MFP 100 executes a billing processing program stored in the ROM 113, the HDD 115 or the CD-ROM 118. With reference to FIG. 12, the CPU 111 included in the MFP 100 determines whether a document is placed (step S01). The CPU 111 waits until it is detected that a document is placed on the document tray 125 (NO in the step S01). If it is detected that a document is placed on the document tray 125 (YES in the step S01), the process proceeds to the step S02.

In the step S02, whether the start key is depressed is determined. If depression of a hard key included in the hard key unit 167 of the operation unit 163 is detected, the process proceeds to the step S03. If not, the process returns to the step S01.

Scan of a document that comes first in a queue starts in the step S03, and the process proceeds to the step S04. Thus, a scan process starts. In the step S04, a preparation process starts. A preparation process can be executed in parallel with a scan process. Therefore, a preparation process and a scan process are executed in parallel in a period during which the scan process is in progress. In the step S05, a collection process starts. A collection process is not executed in parallel with a preparation process. Therefore, a collection process starts after a preparation process ends. A collection process can be executed in parallel with a scan process. Therefore, in the case where a scan process is in progress, a collection process and the scan process are executed in parallel.

A settlement time determining process is executed in the step S06, and the process proceeds to the step S07. While the details of a settlement time determining process will be described below, the settlement time determining process is a process of determining a settlement time and a preparation start time in regard to documents that come second and subsequently in a queue. A settlement time is a point in time at which a collection process starts, and a preparation start time is a point in time at which a preparation process starts. A scan process for the documents that come second and subsequently in the queue starts in the step S07, and the process proceeds to the step S08. A scan process is not executed in parallel with a scan process of a succeeding document. Therefore, a scan process with respect to the documents that come second and subsequently in the queue starts at any point in time after a scan process with respect to a document that comes first in the queue ends.

In the step S08, whether the current point in time is the preparation start time determined by the settlement time determining process executed in the step S06. If the current point in time is the preparation start time, the process proceeds to the step S09. If not, the process proceeds to the step S10. A preparation process starts in the step S09, and the process proceeds to the step S10.

In the step S10, whether the current point in time is the settlement time determined by the settlement time determining process executed in the step S06. If the current point in time is a settlement time, the process proceeds to the step S11. If not, the process proceeds to the step S14. In the step S11, whether a plurality of documents have been scanned is determined. Whether image data corresponding to a document for which a collection process is not executed is stored in the RAM 114 is determined. If a plurality of documents have been scanned, the process proceeds to the step S12. If not, the process proceeds to the step S13. A collective collection process starts in the step S12, and the process proceeds to the step S14. A collective collection process is a collection process of collectively collecting fees for an image process with respect to a plurality of image data pieces which are stored in the RAM 114 and for which a collection process is not executed. A collection process starts in the step S13, and the process proceeds to the step S14. In the step S14, whether a copy process has ended is determined. If a copy process has not ended, the process returns to the step S08. If a copy process has ended, the process ends.

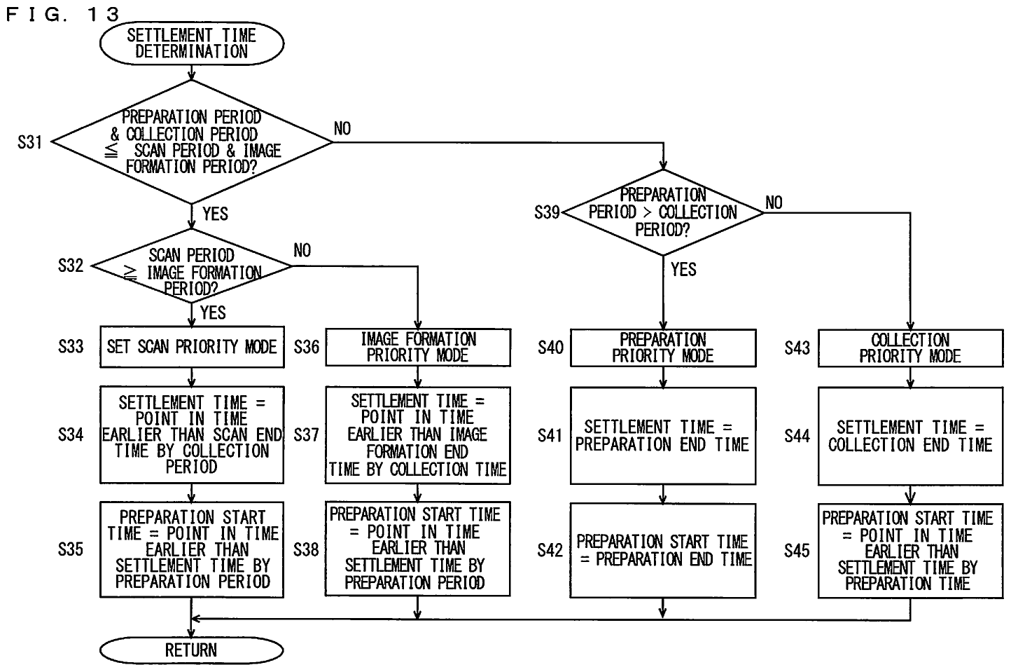

FIG. 13 is a flowchart showing one example of a flow of a settlement time determining process. The settlement time determining process is a process executed in the step S06 of the billing process. With reference to FIG. 13, the CPU 111 included in the MFP 100 determines whether any of a preparation period and a collection period is equal to or smaller than a scan period and equal to or smaller than an image formation period (step S31). If any of the preparation period and the collection period is equal to or smaller than the scan period, and any of the preparation period and the collection period is equal to or smaller than the image formation period, the process proceeds to the step S32. If not, the process proceeds to the step S39.

In the step S32, whether the scan period is equal to or larger than the image formation period is determined. If the scan period is equal to or larger than the image formation period, the process proceeds to the step S33. If the scan period is smaller than the image formation period, the process proceeds to the step S36. A scan priority mode is set in the step S33, and the process proceeds to the step S34. In the step S34, a point in time that is earlier than a scan end time by the collection period is determined as a settlement time, and the process proceeds to the step S35. A scan end time is a point in time at which a scan process with respect to a document subject to a collection process ends. In the step S35, a point in time that is earlier than a settlement time by the preparation period is determined as a preparation start time, and the process returns to the billing process.

An image formation priority mode is set in the step S36, and the process proceeds to the step S37. A point in time that is earlier than an image formation end time by the collection period is determined as a settlement time in the step S37, and the process proceeds to the step S38. An image formation end time is a time point at which an image forming process with respect to a document that comes first in a queue and is subject to a collection process ends. In the step S38, a point in time that is earlier than the settlement time by the preparation period is determined as a preparation start time, and the process returns to the billing process.

In the step S39, whether the preparation period is larger than the collection period is determined. If the preparation period is larger than the collection period, the process proceeds to the step S40. If the preparation period is equal to or smaller than the collection period, the process proceeds to the step S43. A preparation priority mode is set in the step S40, and the process proceeds to the step S41. A preparation end time is determined as a settlement time in the step S41, and the process proceeds to the step S42. In the step S42, a preparation end time with respect to a document that comes one document earlier in a queue is determined as a preparation start time, and the process returns to the billing process.

A collection priority mode is set in the step S43, and the process proceeds to the step S44. A collection end time is determined as a settlement time in the step S44, and the process proceeds to the step S45. A collection end time is a point in time at which a collection process with respect to a document that comes one document before a document subject to a collection process in a queue ends. In the step S45, a point in time that is earlier than the settlement time by the preparation period is determined as a preparation start time, and the process returns to the billing process.

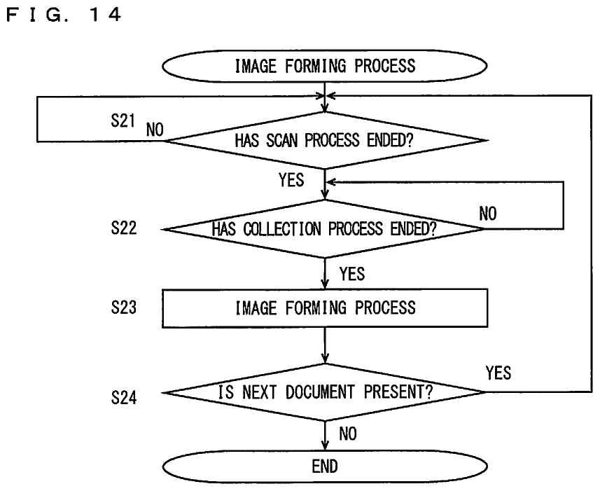

FIG. 14 is a flowchart showing one example of a flow of an image forming process. An image forming process is a process executed by the CPU 111 when the CPU 111 included in the MFP 100 executes a billing processing program stored in the ROM 113, the HDD 115 or the CD-ROM 118. With reference to FIG. 14, the CPU 111 included in the MFP 100 determines whether a scan process has ended (step S21). The CPU 111 waits until the scan process ends (NO in the step S21). If the scan process ends (YES in the step S21), the process proceeds to the step S22. In the step S22, whether a collection process has ended is determined. The CPU 111 waits until the collection process ends (NO in the step S22). If the collection process ends (YES in the step S22), the process proceeds to the step S23. In the step S23, an image forming process starts, and the process proceeds to the step S24. In the step S24, whether a document to be processed next is present is determined. If a document is present, the process returns to the step S21. If not, the process ends.

### First Modified Example

In the present embodiment, the MFP 100 controls the portable information device 200 by wirelessly communicating with the portable information device 200 via the communication I/F unit 112 and causes the portable information device 200 to display an image of a two-dimensional code representing new payment information.

In a first modified example, the user who operates the MFP 100 operates the operation panel 160 and remotely operates the portable information device 200, thereby causing the portable information device 200 to display a two-dimensional code representing newly updated payment information. For example, a screen mirroring a screen displayed in the display of the portable information device 200 is displayed in the display unit 161 of the MFP 100. Mirroring becomes possible by installation of a program for remotely operating the portable information device 200 by the MFP 100 in each of the portable information device 200 and the MFP 100. Thus, the same screen as the screen displayed in the display of the portable information device 200 is displayed in the display unit 161 of the operation panel 160. When the user designate a position in the screen displayed in the display unit 161 with his or her finger, the position in the screen is detected by the touch panel 165 of the operation panel 160, and the detected position is transmitted to the portable information device 200. When the user designates an update button in the same screen as the screen displayed in the display of the portable information device 200 using the touch panel 165 of the operation panel, an image of a two-dimensional code representing newly updated payment information is displayed in the portable information device 200.

### Second Modified Example

In a second modified example, the user is notified of a message requesting update, and the notified user operates the portable information device 200 to cause the portable information device 200 to display an image of a two-dimensional image representing new payment information. The user may be notified of the message by display of the message in the display unit 161 by the MFP 100 or output of the message represented by a synthesized speech from a speaker. For example, the message is “Press the update button since a two-dimensional code is going to expire.”

As described above, in the electronic settlement system 1 in the present embodiment, the MFP 100 functions as an image forming apparatus, executes a scan process of acquiring image data output by the document scanning unit 130 that has scanned a document and executes a collection process of collecting a fee for an image forming process before the image forming process of forming an image of acquired image data is executed. Further, in the case where the document scanning unit 130 scans a plurality of documents successively, the MFP 100 executes a collection process in the order of output of image data by the document scanning unit 130. Therefore, in the case where the plurality of documents are scanned successively, fees for an image forming process of forming images of image data acquired by scan of documents are collected in the order of scan of the plurality of documents, and the image forming process is executed. Therefore, the fees are collected before all of the plurality of documents are scanned. Further, because only an image forming process for which a fee is collected is executed, even in the case where execution of an image forming process is interrupted, a fee is not collected for a document that has not been scanned. Therefore, it is not necessary to refund a fee even in the case where execution of an image forming process is interrupted.

Further, the MFP 100 starts a preparation process for execution of a collection process before the collection process starts. Therefore, a fee for an image forming process can be collected immediately.

Further, in the case where any of a preparation period during which a preparation process is executed and a collection period during which a collection process is executed is equal to or smaller than a scan period and equal to or smaller than an image formation period, and the scan period is equal to or larger than the image formation period, the MFP 100 starts a collection process with respect to a document subject to a scan process during execution of a scan process. Therefore, because a fee is collected by the time when the image forming process is executed, the image forming process can be executed before scan of a next document starts.

Further, the MFP 100 preferably starts a collection process with respect to a second document such that the collection process with respect to the second document that is scanned subsequently to a first document ends at a point in time at which a scan process with respect to the first document ends or later. Therefore, a fee for an image forming process with respect to the second document is collected at a point in time at which an image forming process with respect to the first document ends or later. Therefore, in the case where the image forming process with respect to the second document is not executed, the fee for the image forming process with respect to the second document can be prevented from being collected.

Further, in the case where any of a preparation period during which a preparation process is executed and a collection period during which a collection process is executed is equal to or smaller than a scan period and equal to or smaller than an image formation period, and the scan period is smaller than the image formation period, the MFP 100 starts a collection process with respect to a second document such that a collection process with respect to the second document that is scanned subsequently to a first document ends at a point in time at which an image forming process with respect to the first document ends or later. Therefore, in the case where an image forming process with respect to the second document is not executed, the fee for the image forming process with respect to the second document can be prevented from being collected.

Further, in the case where a preparation period is larger than any of a scan period and an image formation period, and the preparation period is larger than a collection period, the MFP 100 starts a preparation process with respect to a second document that is scanned subsequently to a first document after a preparation process with respect to the first document ends. Therefore, because preparation processes are executed successively, an image forming process can be executed in the shortest period of time.

Further, in the case where a collection period is larger than any of a scan period and an image formation period, and a preparation period is equal to or smaller than the collection period, the MFP 100 starts a collection process with respect to a second document that is scanned subsequently to a first document after a collection process with respect to a first document ends. Therefore, because collection processes are executed successively, an image forming process can be executed in the shortest period of time.

Further, in the case where a plurality of second documents subsequent to a first document have been scanned at a point in time at which a collection process with respect to the first document ends, the MFP 100 collectively collects fees for an image forming process with respect to the plurality of respective second documents. Therefore, in the case where a collection period is larger than a scan period, the fees for the plurality of respective second documents are collectively collected. Thus, the number of collection processes is reduced, and the fees can be collected efficiently.

Further, the MFP 100 acquires payment information representing an account that is registered in the billing server 300 in advance and is assigned to the portable information device 200 from the portable information device 200 as the information relating to a payee of a fee for an image forming process. At this time, the MFP 100 acquires newly updated payment information from the portable information device 200 before a validity period of payment information expires. Therefore, a fee for an image forming process can be collected reliably.

Although embodiments of the present invention have been described and illustrated in detail, the disclosed embodiments are made for purpose of illustration and example only and not limitation. The scope of the present invention should be interpreted by terms of the appended claims

What is claimed is:

1. An image forming apparatus comprising:
a document scanner that scans a document; and
a hardware processor, wherein
the hardware processor
acquires image data output by the document scanner that has scanned a document,
executes an image forming process of forming an image of the image data output by the document scanner, and
executes a collection process of collecting a fee for the image forming process before the image forming process is executed, and
the hardware processor executes the collection process in order of output of the image data by the document scanner in the case where the plurality of documents are scanned successively by the document scanner.

2. The image forming apparatus according to claim 1, wherein
the hardware processor further executes a preparation process for execution of the collection process, and
the hardware processor starts the preparation process such that the preparation process completes before the collection process starts.

3. The image forming apparatus according to claim 2, wherein
the hardware processor, in the case where any of a preparation period during which the preparation process is executed and a collection period during which the collection process is executed is equal to or smaller than a scan period during which the scan process is executed and equal to or smaller than an image formation period during which the image forming process is executed, and the scan period is equal to or larger than the image formation period, executes the collection process with respect to the document subject to the scan process during execution of the scan process.

4. The image forming apparatus according to claim 3, wherein
the hardware processor starts the collection process with respect to a second document such that the collection process with respect to the second document that is scanned subsequently to a first document ends at a point in time at which the scan process with respect to the first document ends or later.

5. The image forming apparatus according to claim 2, wherein
the hardware processor, in the case where any of a preparation period during which the preparation process is executed and a collection period during which the collection period is executed is equal to or smaller than a scan period during which the scan process is executed and equal to or smaller than an image formation period during which the image forming process is executed, and the scan period is smaller than the image formation period, starts the collection process with respect to a second document such that the collection process with respect to the second document that is scanned subsequently to a first document ends at a point in time at which the image forming process with respect to the first document ends or later.

6. The image forming apparatus according to claim 2, wherein
the hardware processor, in the case where a preparation period during which the preparation process is executed is larger than any of a scan period during which the scan process is executed and an image formation period during which the image forming process is executed, and the preparation period is larger than a collection period during which the collection process is executed, starts the preparation process with respect to a second document that is scanned subsequently to a first document after the preparation process with respect to the first document ends.

7. The image forming apparatus according to claim 2, wherein
the hardware processor, in the case where a collection period during which the collection process is executed is larger than any of a scan period during which the scan process is executed and an image formation period during which the image forming process is executed, and a preparation period during which the preparation process is executed is equal to or smaller than collection period, starts the collection process with respect to a second document that is scanned subsequently to the first document after the collection process with respect to a first document ends.

8. The image forming apparatus according to claim 7, wherein
the hardware processor collectively collects fees for the image forming process with respect to the plurality of respective second documents in the case where the plurality of second documents subsequent to the first document have been scanned at a point in time at which the collection process with respect to the first documents ends.

9. The image forming apparatus according to claim 2, wherein
the hardware processor further
acquires payment information in regard to a payee of a fee for the image forming process from an external device, and
acquires newly updated payment information before a validity period of the payment information expires.

10. A billing processing method that is executed in an image forming apparatus,
the image forming apparatus comprising:
a document scanner that scans a document; and
an image former that forms an image, and
the billing processing method including:
a scan controlling step of executing a scan process of acquiring image data output by the document scanner that has scanned the document;
an image formation controlling step of executing an image forming process of causing the image former to form an image of the image data; and
a fee collecting step of executing a collection process of collecting a fee for the image forming process before the image forming process is executed, wherein
the fee collecting step includes executing the collection process in order of output of the image data by the document scanner in the case where the plurality of documents are scanned successively by the document scanner.

11. The billing processing method according to claim 10, including a preparing step of executing a preparation process for execution of the collection process, wherein
the preparing step includes starting the preparation process such that the preparation process completes before the collection process starts in the fee collecting step.

12. The billing processing method according to claim 11, wherein
the fee collecting step, in the case where any of a preparation period during which the preparation process is executed and a collection period during which the collection process is executed is equal to or smaller than a scan period during which the scan process is executed and equal to or smaller than an image formation period during which the image forming process is executed, and the scan period is equal to or larger than the image formation period, includes executing the collection process with respect to the document subject to the scan process during execution of the scan process.

13. The billing processing method according to claim 12, wherein
the fee collecting step includes starting the collection process with respect to a second document such that the collection process with respect to the second document that is scanned subsequently to a first document ends at a point in time at which the scan process with respect to the first document ends or later.

14. The billing processing method according to claim 11, wherein
the fee collecting step, in the case where any of a preparation period during which the preparation process is executed and a collection period during which the collection period is executed is equal to or smaller than a scan period during which the scan process is executed and equal to or smaller than an image formation period during which the image forming process is executed, and the scan period is smaller than the image formation period, starts the collection process with respect to a second document such that the collection process with respect to the second document that is scanned subsequently to a first document ends at a point in time at which the image forming process with respect to the first document ends or later.

15. The billing processing method according to claim 11, wherein
the fee collecting step, in the case where a preparation period during which the preparation process is executed is larger than any of a scan period during which the scan process is executed and an image formation period during which the image forming process is executed, and the preparation period is larger than a collection period during which the collection process is executed, starts the preparation process with respect to a second document that is scanned subsequently to a first document after the preparation process with respect to the first document ends.

16. The billing processing method according to claim 11, wherein
the fee collecting step, in the case where a collection period during which the collection process is executed is larger than any of a scan period during which the scan process is executed and an image formation period during which the image forming process is executed, and a preparation period during which the preparation process is executed is equal to or smaller than collection period, starts the collection process with respect to a second document that is scanned subsequently to the first document after the collection process with respect to a first document ends.

17. The billing processing method according to claim 16, wherein
the fee collecting step includes collectively collecting fees for the image forming process with respect to the plurality of respective second documents in the case where the plurality of second documents subsequent to the first document have been scanned at a point in time at which the collection process with respect to the first documents ends.

18. The billing processing method according to claim 11, further including:
a payment information acquiring step of acquiring payment information in regard to a payee of a fee for the image forming process from an external device, and
an updating step of acquiring newly updated payment information before a validity period of the payment information expires.

19. A non-transitory computer-readable medium encoded with a billing processing program that is executed in a computer that controls an image forming apparatus including a document scanner that scans a document,
the billing processing program causing the computer to execute:
a scan controlling step of executing a scan process of acquiring image data output by the document scanner that has scanned the document;
an image formation controlling step of executing an image forming process of causing the image former to form an image of the image data; and
a fee collecting step of executing a collection process of collecting a fee for the image forming process before the image forming process is executed, wherein
the fee collecting step includes executing the collection process in order of output of the image data by the document scanner in the case where the plurality of documents are scanned successively by the document scanner.
